(19) United States
(12) Patent Application Publication
(10) Pub. No.: US 2015/0294537 A1
(43) Pub. Date: Oct. 15, 2015

(54) GAME MANAGEMENT SYSTEM

(71) Applicant: CASICON CO., LTD., Tokyo (JP)

(72) Inventor: Tatsuya Chujo, Nagakute-shi (JP)

(73) Assignee: CASICON CO., LTD., Tokyo (JP)

(21) Appl. No.: 14/437,984

(22) PCT Filed: Oct. 25, 2012
(86) PCT No.: PCT/JP2012/077586

§ 371 Date: Apr. 23, 2015

(51) Int. Cl. G07F 17/32

(52) U.S. Cl. CPC G07F 17/3288; G07F 17/3244

(57) ABSTRACT

A game management unit 21 manages a game where a customer inputs a resource to participate in and an agent gives a resource to the customer in accordance with a result. A record management unit 22 manages a game record of each customer based on the input resource and the given resource An allocation determination unit 23 determines allocation of a different resource different from the input and given resources to the customer based on the customer's gamed record. A different resource determination unit 24 determines a type or an amount of the different resource allocated to the customer based on the customer's game record. A different resource allocation unit 25 allocates, to the customer to whom the different resource is determined to be allocated by the allocation determination unit, the different resource of the type or the amount determined by the different resource determination unit.

### TECHNICAL FIELD

The invention relates to a system used for managing a type of game where a customer inputs money or points (hereinafter generally referred to as a resource) to participate in and acquires, in accordance with a result of the game, a resource from an agent who manages the game. Examples of the game include horse races, cycle races, motorboat races, car races, various kinds of gambles performed in casinos, and public lotteries.

### BACKGROUND ART

There are a large number of government-controlled or authorized gambles in the world. In Japan, there are so-called “Sankei auto” (generally referring to races including the horse races, the cycle races, the motorboat races, and the car races), public lotteries, toto (the soccer pools), and the like. Integrated casino resorts are also common worldwide, and legalization of these casino resorts is discussed in Japan in recent years. The integrated casino resorts are used for such purposes as increasing financial profits, activating regional economies, and increasing employment.

The source of the sales in these casinos is a stochastically set house edge. The house edge of the “Sankei auto” (including the horse races, the cycle races, the motorboat races, and the car races) is set to about 25%, while the house edge of the public lotteries, toto (the soccer pools), and the like is set to about 50%, respectively. In casinos, the house edge varies depending on the types of game. In the case of roulettes, the house edge is 5.26%. Here, these house edges are only mathematically expected values, and are not always equal to actual sales. Accordingly, the house edges are diversified in the range of deviation.

Today, there is a point reward service, such as used in RAKUTEN KEIBA® (Rakuten horse race), that give points in accordance with the purchase amount of betting tickets. In casinos, there is also a point return service wherein points are returned in accordance with expected values or lost values calculated based on the content of play performed by customers (the amount of bets, the frequency of participation).

Other inventions relating to point return to customers are disclosed in Patent Documents 1 to 3. A betting ticket issuing device is disclosed in Patent Document 1, wherein points are given according to a purchase amount for every purchase of betting tickets. A point assignment device is disclosed in Patent Document 2, wherein the degree of unluckiness for a missed bet, which indicates how its prediction is close to a hit, is calculated, and points are assigned to the purchaser of the bet according to the calculated degree of unluckiness and the purchased amount of the bet. A managing system for game hall is disclosed in Patent Document 3, wherein a player registers an achievement target as a point assignment condition. When the target is achieved, points are given to the player.

### CITATION LIST

### Patent Document

Patent Document 1: JP 4808943B

Patent Document 2: JP 4344777B

Patent Document 3: JP 4303018B

### SUMMARY OF INVENTION

### Technical Problem

An existing program in the aforementioned RAKUTEN KEIBA® simply applies point return programs appendant to sale of other consumer commodities to the gambles and the like. Therefore, it is not the program constructed from a probabilistic viewpoint and is not suitable for gambles having a property in which sales is uncertain and a set value (house edge) tends to deviate from an actual sales.

The existing return systems in casinos are also lack of precision. All the existing services are programs made in a rough viewpoint that “in a long term, preset expected value become close to the actual sales on the whole customers” constructed on the basis of the law of large numbers This may possibly create a large risk depending on return methods or the amount thereof.

For example, a customer who bet 10,000 yen 100 times and won 30,000 yen, a customer who bet 100,000 yen 10 times and lost 50,000 yen, and a customer who bet 1 million yen once and won 1 million yen are all equal in the total amount of bets, and so their expected values (52,600 yen with the house edge being 5.26%) are the same, and thus they are recognized as the customers of the same level. Therefore, for example, if the point return ratio is set to 1%, the amount to be paid is 10,000 yen. However, since these three customers are different in the amount of each bet and the frequency of betting, their results show stochastic diversity. Because of this reason, stochastic set values and actual game results also show diversity, which increases the possibility of causing deviation. Therefore, point return in gambles should be controlled by a program created in consideration of deviation.

There is also a service to return points in accordance with the amount of lost bets. In this service, however, the return rate is uniformly set in accordance with the amount of lost bets. Assume a case in the same example as described above, points are returned to a customer who bet 10,000 yen 200 times and lost 1 million yen, a customer who bet 100,000 yen 50 times and lost 1 million yen, and a customer who bet 1 million yen once and lost 1 million yen, respectively. If the point return ratio is set to e.g. 10%, all the customers receive the same amount, 100,000 yen. However, due to the difference in the amount of each bet and the frequency of betting, actual game results in this case also show stochastic diversity. It can be considered that the customers lost the same amount of money by chance. However, the existing system does not take the results due to such difference in deviation or the results by chance into consideration, and refunds at a fixed percentage, which causes a risk of loss in terms of probability.

This problem is not addressed in the patented inventions disclosed in the aforementioned Patent Documents.

As indicated in the above examples, in gambles, based on the law of large numbers, the actual amount of lost bets and expected values are to be balanced in a long term. However, short-term and mid-term results include diversity caused by betting styles and the amount of each bet.

It is ineffective to manage the above-stated three customers by a stereotypical program not only from the viewpoint of agents but also from the viewpoint of customer service.

In gambles, the following tendency is important in particular. That is, the customers, who have a high ratio of a given resource to an input resource (hereinafter referred to as winning percentage), tend to keep on participating in the game without any persuasion from the agent, since they receive the resource when they participate in the game. In contrast, the customers, who have a low winning percentage and have input a large amount of resources to be discouraged from participating in the game, since their loss becomes larger. Under these circumstances, the agent needs to consider the customers having a low winning percentage and a large amount of input resource. However, the system which can take such circumstances into consideration does not exist in the conventional technology.

Here, in the games such as the existing public gambles, an agent cannot change the rule of giving resources to participating customers during holding a game for each customer from the perspective of fairness. The agent needs to apply the same resource giving rule to all the customers regardless of their game records. Therefore, changing the game winning percentage or point assignment rate of the customers who satisfy a certain play condition during execution of the game is not applicable to the games such as existing public gambles. For example, a point assignment system, conventionally known in mobile games using mobile terminals and the like, is characterized by changing the winning percentage of the customers who reach a certain record during execution of a game or assigning points or items to be used inside the game. Such a point assignment method is inapplicable to the games such as existing public gambles.

Furthermore, game machines currently used in public gambles are required to be inspected, authorized, and registered by law. Accordingly, changing probabilities or payment rates take considerable effort, expense, and time. Therefore, techniques of motivating customer's consumption are restricted and are not feasible actually.

The invention has been proposed in order to solve the problems of the conventional technologies as described above. An object of the invention is to suppress a decrease in customers, under the restriction that it is difficult to flexibly change the rule of providing resources, such as the house edge, from the perspective of fairness and the like, the decrease in customers being caused by deviation inevitably generated in a game, which discourages customers who temporarily face excessive loss from participating in the game and which causes the customers to hurry away from the game against the intension of an agent.

### Solution to Problem

The game operations system of the invention includes: a game management unit configured to manage a game where a customer inputs a resource to participate in and an agent gives a resource to the customer in accordance with a result; a record management unit configured to manage a game record of each customer based on an input resource and a given resource in the game; an allocation determination unit configured to determine to allocate a different resource to the customer based on the game record of the customer, the different resource being different from the input resource and the given resource in the game; a different resource determination unit configured to determine a type or an amount of the different resource allocated to the customer, based on the game record of the customer; and a different resource allocation unit configured to allocate, to the customer to whom the different resource is determined to be allocated by the allocation determination unit, the different resource of the type or the amount determined by the different resource determination unit.

### Advantageous Effects

According to the invention having the configuration as describe above, different resources are provided in accordance with the records of the customers. This makes it possible to lower the house edge that is seen from a total including the different resource. Accordingly, the customers become less conscious of their losing, which can prevent the customers from hurrying away from the game so that reduction in profit can be suppressed.

### BRIEF DESCRIPTION OF DRAWINGS

FIG. 1 is a block diagram illustrating the function configuration of a game management system according to a first embodiment of the invention.

FIG. 2 is a flow chart illustrating an operation flow of the game management system according to the first embodiment of the invention.

FIG. 3 is a block diagram illustrating the function configuration of a game management system according to a second embodiment of the invention.

FIG. 4 is a view illustrating one example of a different resource management file.

FIG. 5 is a view illustrating one example of history information.

FIG. 6 is a view illustrating one example of record information.

FIG. 7 is a block diagram illustrating the function configuration of a game management system according to a third embodiment of the invention.

FIG. 8 is a view illustrating the status of each customer after segmentation processing.

FIG. 9 is a view illustrating different resources allocated to customers.

FIG. 10 is a block diagram illustrating the function configuration of a game management system according to a fourth embodiment of the invention.

FIG. 11 is a view illustrating a customer-side house edge and an agent-side house edge.

FIG. 12 is a view illustrating a customer-side house edge and an agent-side house edge set for each segment as a target value.

### DESCRIPTION OF EMBODIMENTS

Hereinbelow, each embodiment of the invention will be described in detail with reference to the drawings. In the following description, component members designated by identical reference numeral have substantially identical functions. To clarify the invention, description of overlapped components is properly omitted.

### First Embodiment

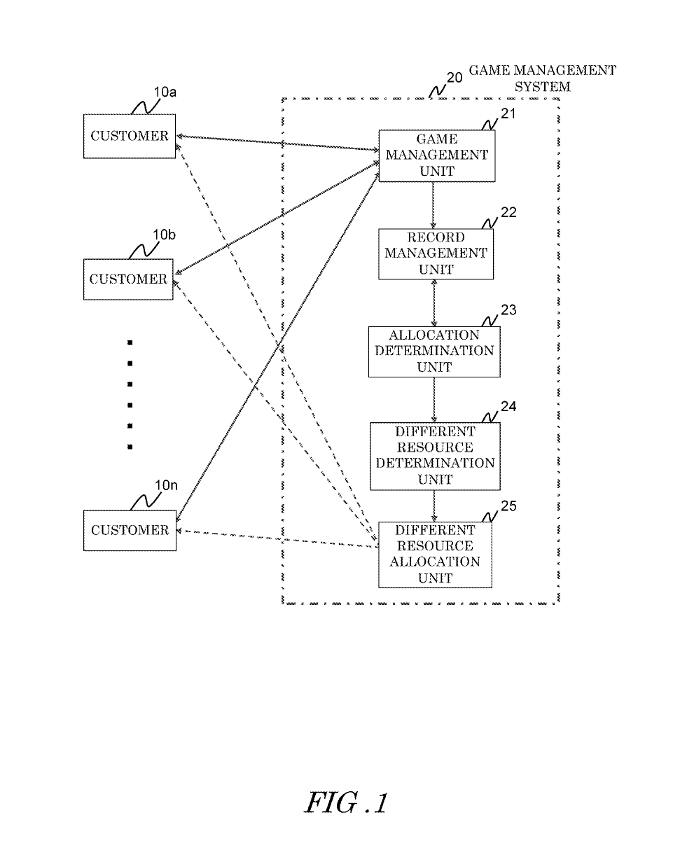

FIG. 1 illustrates an overall system according to the first embodiment. An agent who is a main body of a game management provides a game for a large number of customers 10a to 10n who participate in the game by using a game management system 20. Customers each input a resource and the agent gives a resource to the customers in accordance with their results so that the game is established.

In this case, the “resource” input in the game is preset by the agent as a resource dedicated for the game, the resource including money paid by the customers to the agent for participating in the game, credits, points, and chips exchangeable with cash and commodities. The resource given to the customers from the game is preset by the agent as a resource dedicated for the game, the resource including money, credits, points, commodities or tickets as a prize, and chips exchangeable with cash and commodities.

This game management system 20 includes a game management unit 21, a record management unit 22, an allocation determination unit 23, a different resource determination unit 24, and a different resource allocation unit 25.

The game management unit 21 is a unit of managing a game where a customer inputs a resource to participate in and an agent gives a resource to the customer in accordance with a game result. The game management unit 21 is configured to perform execution of a game, management of the resource that the customers input in the game, management of the resource to be given to the customers by the agent, management of a profit and loss account of the game, and the like.

Here, the game managed by the game management unit 21 is as follows.
(a) The agent applies the same resource giving rule to all the participating customers regardless of their game records without changing the resource giving rule for individual customers during holding the game.
(b) While the customers are participating in the game, the different resources will not be given to the customer via the game except a case of giving the resource on the basis of winning or losing of the game to the customers.

Here, the “different resources” are different from the “resource” input and given in the game managed by the game management unit 21. Unlike the resource preset by the agent, the different resources cannot directly be input in the game managed by the game management unit 21. However, the different resources include resources, such as points and free participation tickets to the game, which can be exchanged with the resource to be input in the game or which can be input in the game in place of the resource to be input in the game. The “different resources” also include a privilege to participate in another game (secondary game) independent of the game managed by the agent via the game management unit 21, the secondary game being executed on terminals owned by the customers.

The rules (a) and (b) signify that the winning percentage of the game managed by the game management unit 21 itself is not influenced by the number of times that the customer participates in the game, the amount of the resource input by the customer, and the winning percentage of the customer. More specifically, in the public gambles or casinos, the same giving rule is applied to all the customers from the perspective of fairness. The invention relates to the system for managing the game that ensures such fairness. The game management unit 21 executes the game in compliance with the aforementioned resource giving rule.

For example, in the case of the games such as horse races and cycle races, the game management unit 21 is constituted of a computer system or the like, which manages calculation of sales and odds of betting tickets for the horse and cycle races, management of winnings, and management of orders of entry, start and arrival. In the case of casinos, the game management unit 21 is constituted of a computer system or the like, which manages various kinds of game machines operated in the casinos, such as slot machines, card game machines, and roulettes, and manages bets and winnings of customers in these games. In the case of computer games and the like, the game itself functions as the game management unit 21.

The record management unit 22 manages a game record of each customer based on the input resource and the given resource in the game managed by the game management unit 21. The record management unit 22 analyzes and stores relevance among actual winning and losing results, expected values, winning percentages, deviations, diversity, and the like of the customer in the game.

The allocation determination unit 23 determines to allocate, a different resource to the customer based on the game record of the customer, the different resource is different from the resource input and given in the game managed by the game management unit 21 to the customer.

For example, the allocation determination unit 23 decides whether or not the game record of the customer managed by the record management unit 22 is lower than a reference record by a predetermined threshold value or more, and determines to allocate the different resource to the customer if the record is lower than the reference record. Here, the reference record referred by the allocation determination unit 23 as a comparative object is determined based on the aforementioned resource giving rule.

Specifically, stochastic values preset by the agent, such as a house edge, an expected value and a winning percentage, are used as the reference record. The allocation determination unit 23 decides whether or not these values that are obtained from actual game results of the customer are lower than the reference record by a predetermined value or more.

For example, assumed is a case where the game managed by the game management unit 21 is a horse race wherein a house edge of 25% is set in conformity to the resource giving rule, and a customer purchases twenty 500-yen voting tickets. In this case, an expected profit value that the agent expects to earn from the customer is 2,500 yen obtained by multiplying 10,000 yen that is a total resource that the customer input in the game by the house edge of 25% preset for the game. From the viewpoint of the customer, when a bet worth of 10,000 yen is input as a resource, a return worth of 7,500 yen is expected to be earned from the agent. From another point of view, the customer is expected to lose 2,500 yen. Here, each of this house edge and the expected value is used as a reference record.

Since the game has uncertainty, a return exceeding 7,500 yen is earned from an input of 10,000 yen in some cases, while a return only less than 7,500 yen is earned in other cases. That is, a deviation is generated.

Here, assumed is a case where the above-stated customer has a poor game record and has lost 9,000 yen and earned a return of only 1,000 yen. In this case, the house edge of this customer turns out to be 90%, which is considerably deviated from the house edge of 25% preset by the agent.

In such a case, the allocation determination unit 23 determines to allocate a different resource to this customer. For example, when the resource that the customer input is 10,000 yen or more and the house edge becomes lower than the preset house edge by 50% or more, the allocation determination unit 23 determines to allocate a different resource.

The allocation determination unit 23 is more preferably configured to decide whether or not the number of times that the customer participated in the game is over a predetermined threshold value. If the number of times is over the threshold value, the allocation determination unit 23 determines to allocate the different resource. For example, when the number of times that the customer participated in the game is 20 or more, the allocation determination unit 23 can determine to allocate the different resource.

The different resource determination unit 24 determines a type or an amount of the different resource to be provided to the customer based on the game record of the customer.

For example, the different resource determination unit 24 determines the type or the amount of the different resource to be allocated to the customer such that upon compared to a reference record, the difference between the record of the customer including the different resource to be allocated and the reference record is within a predetermined threshold.

In this case, the different resource determination unit 24 determines the type or the amount of the different resource such that the cost (expense) incurred by allocating the different resource falls within an additional cost range permitted for this customer.

The different resource allocation unit 25 allocates, to the customer to whom the different resource is determined to be allocated by the allocation determination unit 23, the different resource of the type or the amount determined by the different resource determination unit 24.

Since the different resource is allocated to the customer by the different resource allocation unit 25, even when the ratio of the given resource to the input resource is lower than the ratio preset by the agent, a ratio of the total resource including the given resource and the different resource to the input resource becomes closer to the ratio preset by the agent. Accordingly, the customer becomes less conscious of his/her losing, which increases the possibility of the customer keeping on inputting the resource to the game. This ensures that the agent can gain the profit.

For example, in the above example, the agent gains the resource worth of 9,000 yen from this customer. However, if the customer stops participating in the game, this 9,000 yen is a limit of the resource which can be gained from this customer. Here, assumed is a case that the different resource is allocated to the customer and thus the customer continues to participate in the game and inputs a resource worth of total 50,000 yen. In this case, even when the house edge of this customer returns to the preset ratio of 25%, the agent still gains 12,500 yen from this customer. For example, assumed is a case that the agent allocates a 5,000-yen different resource of which purchase price is 500 yen. In this case, the agent still earns from this customer a profit of 12,000 yen in a return flow of the overall resource including the different resource. As compared with the case where the different resource is not allocated, a profit increase of 3,000 yen is achieved.

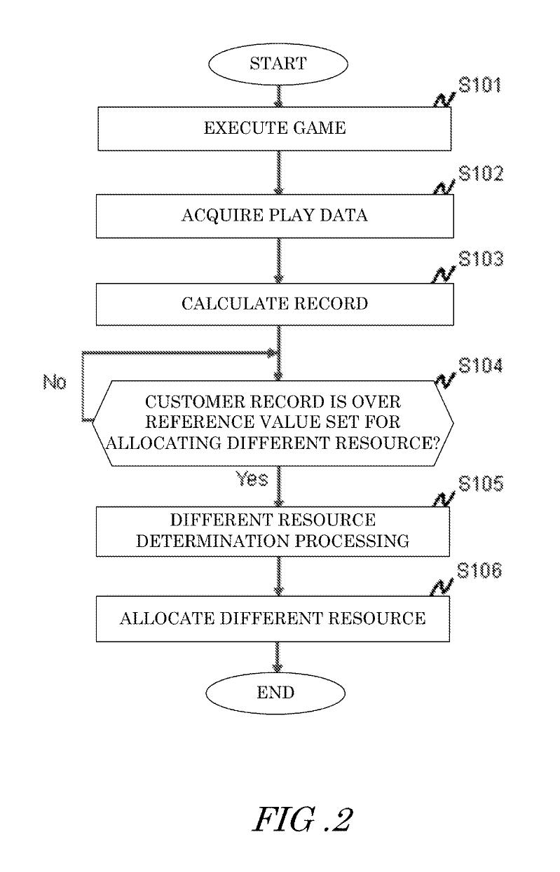

Next, the operation of the game management system 20 is described with reference to the flow chart of FIG. 2.

The game management unit 21 executes the game based on the resource input by the customer, and gives a resource to the customer in accordance with the result of the game (step S101).

The game management unit 21 then acquires play data on each customer who participated in the game (step S102). Here, the play data includes information of the amount of the resource input by each customer, the winning and losing result of the game, the amount of the resource to be given, and the like. The play data of each customer acquired by the game management unit 21 is sent to the record management unit 22.

The record management unit 22 calculates the game record of each customer based on the input resource and the given resource, on the basis of the play data sent from the game management unit 21 (step S103).

Next, the allocation determination unit 23 determines whether or not a different resource is allocated to a customer based on the game record of the customer (step S104). When the game record of the customer is not over the preset reference value, then the allocation determination unit 23 determines not to allocate the different resource in this stage, and is on standby.

Contrary to this, when allocation of the different resource to the customer is determined in step 5104, the different resource determination unit 24 determines, based on the game record of the customer, the type or the amount of the different resource to be provided to this customer (step S105).

The different resource allocation unit 25 allocates the different resource of the type or the amount determined in step S105 to the customer (step S106).

In accordance with the aforementioned flow, a shortage in the “resource” expected to be returned from the agent to the customer is compensated in the form of the “different resource” through another route. Accordingly, in the game executed by the game management unit 21, it becomes possible to suppress the customer being discouraged from participating in the game, thereby leading to profit increase, even under the restriction that the resource giving rule cannot flexibly be changed.

The gamble industry has conventionally taken no measure to control the deviation generated in the game and diversity of the results. Only the free service or benefits have been provided through customer loyalty programs which simply motivate the customers to use more resources, to bet more money and to participate in more games. The industry has not yet reached the level of executing more precise control. As compared with this conventional practice, the first embodiment of the invention can flexibly motivate each customer based on their game records that change as the game progresses, so that the profit can be controlled.

In the above description in accordance with the above-stated processing flow, the different resource determination unit 24 determines the type or the amount of the different resource to be provided to the customer based on the determination made by the allocation determination unit 23. However, the invention is not limited thereto. The different resource determination unit 24 may determine a different resource expected to be allocated with reference in real time to the records managed by the record management unit 22, and the different resource allocation unit 25 may allocate to the customer the different resource predetermined by the different resource determination unit 24, based on the determination made by the allocation determination unit 23.

### Second Embodiment

The game management system according to the second embodiment transmits data of the “different resource” to a mobile terminal owned by the customer who participates in the game so as to allocate the different resource in real time. Hereinafter, a detailed description is given with reference to the drawings. A description of the component members already described in the first embodiment will be partially omitted.

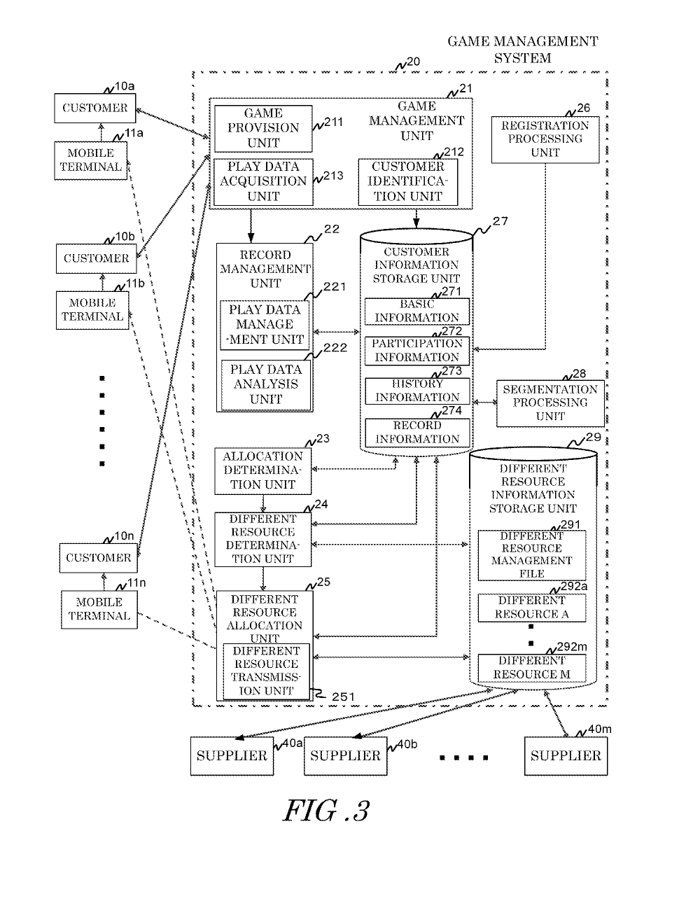

FIG. 3 is an overall view of the system according to the second embodiment. Customers 10a to 10n who participate in the game possess mobile terminals 11a to 11n like cellular phones or mobile personal computers, respectively. Although the terminals 11a to 11n are mobile in the present embodiment, they may be fixed terminals like personal computers placed in their houses and the like. The terminals 11a to 11n have a secondary game execution software and a display processing software downloaded in advance for displaying image data, such as commodity names, commodity prices, and free coupons.

The agent who is a main body of the game affiliates with a plurality of suppliers 40a to 40m who supply different resources. The game management system 20 used by the agent for managing the game manages information of different resources which can be provided for the customers 10a to 10n. Here, the suppliers 40a to 40m are companies or stores which sell or provide the customers 10a to 10n with various commodities and services free of charge or at bargain prices.

The game management system 20 includes a game management unit 21, a record management unit 22, an allocation determination unit 23, a different resource determination unit 24, and a different resource allocation unit 25. The game management system 20 additionally includes a registration processing unit 26, a customer information storage unit 27, a segmentation processing unit 28, and a different resource information storage unit 29.

The registration processing unit 26 performs membership registration processing of the customers. When a customer is going to participate in the game, which is provided by the agent using the game management system 20, for the first time, the customer inputs his/her own information through his/her own terminal or a special terminal established by the agent. The registration processing unit 26 completes registration processing by storing the input information together with a newly allocated membership number in the customer information storage unit 27 as basic information on the customer.

Here, the basic information on the customer includes a name, a sex, an age, an occupation, an address, a contact address of the customer. When the customer owns a mobile terminal 11, information on the mobile terminal 11 is also registered as a part of the basic information. The information on the mobile terminal 11 is the information used by the game management system 20 to access the mobile terminal 11. Examples of the information are an ID of the mobile terminal 11 and an IP address thereof, as well as an e-mail address, a telephone number, and an authentication password. These pieces of information are also stored in the customer information storage unit 27 as basic information to manage the terminal of each customer who participates in the game.

The customer information storage unit 27 stores the customer information of each customer who participates in the game. The customer information includes, in addition to the aforementioned basic information 271, participation information 272 indicating whether or not the customer is participating in the game, history information 273 that is a collection of past game data played by the customer, and record information 274 of the game record of the customer. These pieces of information are stored in association with each other in the customer information storage unit 27. Specifically, the customer information storage unit 27 is a database placed inside the system being built in or connected to a game machine or a ticket issuing machine.

The segmentation processing unit 28 performs processing to segment the customers. By this processing, each customer is placed in one of the segments. The processing to segment the customer based on predetermined conditions is equivalent to the processing of ranking the customers based on a predetermined threshold value. Therefore, the segmentation processing unit 28 may be regarded as a rank setting unit to set each customer in a predetermined rank based on a predetermined evaluation index.

The segmentation processing unit 28 segments each customer based on at least the amount of the resource input by the customer and the amount of the resource given to the customer. Therefore, the segment to which the customer belongs relates to the game record of the customer.

As segments set by the segmentation processing unit 28, there may be segments such as a low customer segment, a middle customer segment, and a high customer segment, which are set based on values set by the agent. For example, the segmentation processing unit 28 is configured to process segmentation by classifying respective customers as follows: the customer whose total amount of bets as the input resource is less than 100,000 yen is classified into the low customer segment; the customer of 100,000 yen or more and less than 1 million yen is classified into the middle customer segment; and the customer of 1 million yen or more is classified into the high customer segment.

The segmentation processing unit 28 may also be configured to segment each customer in accordance with the amount of money owned by each customer. It is preferable that the segmentation processing unit 28 is configured to segment the customer more finely based on the amount of the resource input by the customer at one time, the number of times that the customer participate in the game, the frequency of participation in the game, the type of the game to participate in, and the like, so that the different resource can be allocated more appropriately. It is also possible to use other segmentation criteria such as the occupation, the address, the sex, and the age of the customer.

More preferably, the segmentation processing unit 28 segments the customers based on the total amount of the resource input by the customer and the winning percentage of the customer indicating the percentage to win the game. The customer, whose total amount of the input resource is large while the winning percentage being low, has a high possibility of being discouraged from participating in the game. Therefore, such customers are segmented by using the above stated indexes in the game record of the customers, so that an appropriate different resource can be applied thereto.

Another preferable segmentation index is the number of times of participation in the game. This is because the number of times of participation in the game is a factor that exerts the greatest influence on deviation values as well as on the law of large numbers. Therefore, the segmentation processing unit 28 more preferably segments each customer by using the number of times that the customer participated in the game as one of the indices.

The different resource information storage unit 29 stores information of different resources allocatable to the customer. The different resource information storage unit 29 stores basic data of external sales companies including names, addresses, and contact addresses of the supplies 40a to 40m which supply different resources to the agent. In addition, free services, coupons, and commodities supplied by these companies and selling prices and cost prices thereof, and the like are stored. These pieces of information are collected into a different resource management file 291 and are stored in the different resource information storage unit 29.

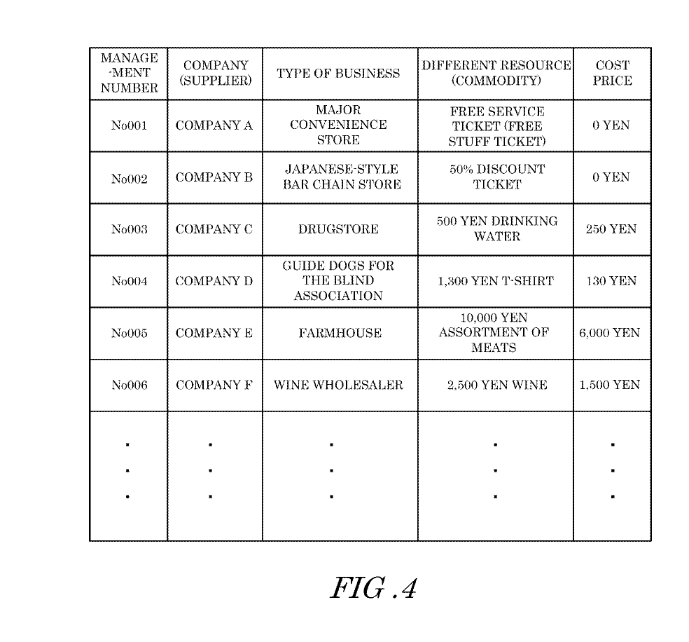

FIG. 4 illustrates one example of the different resource management file 291 that is a collection of information of allocatable different resources. In the example of FIG. 4, companies (suppliers) which supply different resources, types of industry of the companies, the concrete information of the different resources, and cost prices of the different resources are collected. The different resource information storage unit 29 stores image data for displaying these different resources such as coupons. Information of the types, amount, terms, conditions, store addresses, and the like of the allocatable different resources may further be collected in the different resource management file 291. In the case where the amount and the like of the allocatable different resources are limited, a different resource updating unit is separately placed inside the system for updating allocatable different resources based on the different resources allocated by the different resource allocation unit 25.

The game management unit 21 includes a game provision unit 211, a customer identification unit 212, and a play data acquisition unit 213.

The game provision unit 211 provides a game where a customer inputs a resource to participate in and an agent gives a resource to the customer in accordance with a game result. The game provision unit 211 is specifically a game machine and the like such as a slot machine and a roulette which are set by the agent.

The customer identification unit 212 identifies a customer who participates in the game provided by the game provision unit 211. The customer identification unit 212 reads out and updates participation information 272 of the identified customer stored in the customer information storage unit 27, by which the current status of each customer is grasped. The customer identification unit 212 can use a method of photographing customers who are going to participate in the game with a separately placed camera and identifying the customer by using a face authentication system and the like. The customer identification unit 212 can also use a method for identifying customers, in which the customers who are going to participate in the game hold an IC card over a reading device attached to the game machine.

The play data acquisition unit 213 acquires play data of the customer who participates in the game provided by the game provision unit 211, and sends it to the record management unit 22. Here, the play data includes information of the resource input by the customer, the record in the game (winning and losing result), and the resource given to the customer in accordance with the record. Whenever the game provided by the game provision unit 211 is finished, the play data acquisition unit 221 acquires the play data in the game, and sends it to the record management unit 22.

The record management unit 22 includes a play data management unit 221 and a play data analysis unit 222.

The play data management unit 221 updates a play history by adding the play data of the customer acquired by the play data acquisition unit 213 to the history information 273 of the customer stored in the customer information storage unit 27.

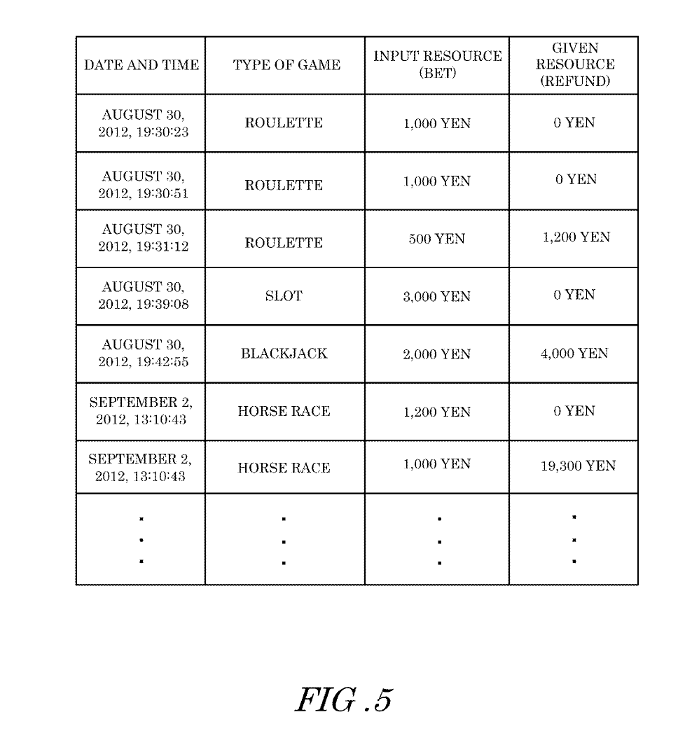

FIG. 5 illustrates one example of the history information 273 updated by the play data management unit 221. The history information 273 includes at least information of types of played games, the input resource (amount of bets), and the given resource (winning) recorded in time series.

The play data analysis unit 222 performs analysis based on the play data such as the resource input in the game so far, the given resource, and actual winning and losing results and obtains expected values, winning percentages, deviations, diversity, and the like. The play data analysis unit 222 stores the obtained information in the customer information storage unit 27 as the record information 274 regarding the record of the customer.

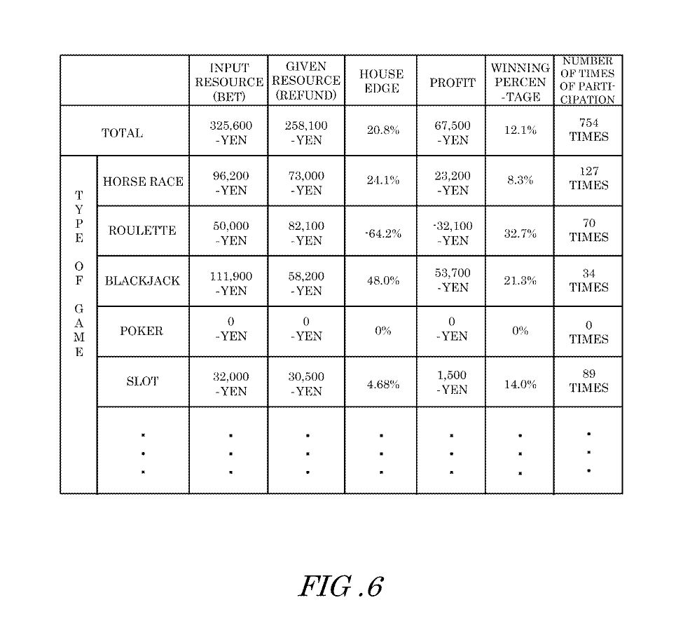

FIG. 6 illustrates one example of the record information 274 updated by the play data analysis unit 222. In the example of FIG. 6, the record information 274 includes the total amount of the resource input so far, the total amount of the resource given so far, the house edge of the customer calculated based on these values, the profit that the agent gained from this customer, the winning percentage, and the number of times of participation in the games. The play data analysis unit 222 calculates data of each of these items for each game, and records the data as part of the record information 274.

The allocation determination unit 23 determines whether or not to allocate to the customer a different resource that is different from the resource input and given in the game provided by the game provision unit 211. Specifically, the allocation determination unit 23 determines to allocate to the customer a different resource based on the game record of the customer and a reference game record.

The different resource determination unit 24 determines the type or the amount of the different resource provided to the customer. Specifically, the different resource determination unit 24 selects, based on the information of the customer record or the segment that the customer belongs to, the type or the amount of the different resource to be allocated, from among allocatable different resources stored in the different resource information storage unit 29.

The different resource allocation unit 25 allocates to the customer the different resource of the type or the amount selected by the different resource determination unit 24, based on the determination made by the allocation determination unit 23. The different resource allocation unit 25 includes a different resource transmission unit 251. The different resource transmission unit 251 acquires an address and the like of the mobile terminal 11 of the customer by referring to the basic information stored in the customer information storage unit 27, and transmits data of the different resource to the mobile terminal 11 for allocation of the different resource. For example, the different resource transmission unit 251 transmits, to the mobile terminal 11, image data of coupons, bar code image data of commodities to be exchanged for free, data including an address linked to the page of commodities to be purchased for free, and the like, in accordance with the type of the different resource to be allocated.

The mobile terminal 11 receives the data of the different resource transmitted from the different resource transmission unit 251, and executes the display software to display the data of the different resource on a display panel. The customer can see the screen displayed on the display panel of the own mobile terminal 11 and check the different resource allocated to him/herself.

As described above, the invention according to the second embodiment further includes the customer information storage unit 27 configured to store customer information including at least the information of the mobile terminal 11 owned by the customer. The different resource allocation unit 25 transmits, to the mobile terminal 11 owned by the customer to whom the different resource is determined to be allocated by the allocation determination unit 23, the data of the different resource of the type or the amount determined by the different resource determination unit 24.

According to the invention in the second embodiment, it becomes possible to perform flexible profit control by displaying various motivating services in real time on the mobile terminal 11 of the customer during the game, while taking into consideration a difference between an actual winning and losing result and an expected value that changes at every moment by participating in the game continuously.

In a business model of a gamble which earns a profit by an accidental phenomenon, a difference between an expected value, which is a stochastic set value, and an actual winning and losing result is generated by various factors. However, in the invention according to the second embodiment, the difference can be corrected from a mathematical viewpoint.

In addition, the secondary free service, which is intentionally selected based on the profitability of the customer and the setting by the agent, is displayed on the mobile terminal 11. When the customer uses this complimentary in local regions, part of the profit of the gamble can appropriately be distributed to regional economies.

An original reason why the gambles are approved is to absorb floating money and returning the money to the society. In the present legal structure and system, part of sales is paid to the government as levy and is used for maintenance of infrastructures, construction and management of facilities, donation to nonprofit organizations and is used as a source of revenue for emergency restoration, as determined by agencies concerned such as the central government and local governments.

Therefore, there are few opportunities for general companies and people to enjoy profits directly from the return money. It cannot be said, therefore, that the gamble industry flexibly plays its role of supporting the development of the society, which is the original reason that the gambles are approved.

Contrary to this, according to the invention in this second embodiment, part of money input in gambles is returned to the customers in the form of different resources directly usable in the markets, such as free coupons and gift certificates, which can activate the economy. In particular, when locally limited coupons are positively selected based on customer addresses and the like for profit return, it becomes possible to aid activation of the regional economies which tend to slow down. The significance of introducing the invention is enhanced in comparison with the existing gambling systems wherein money is simply transferred between agents and customers.

In this case, the different resource determination unit 24 determines the type or the amount of the different resource based on the customer address. For example, the different resource determination unit 24 determines coupons, discount tickets and the like usable in the area including the customer address as the different resource to be allocated to the customer.

The allocation determination unit 23 and the different resource determination unit 24 are more preferably configured to determine whether or not the different resource is allocated and to determine the type or the amount of the different resource to be allocated, based on the number of times that the customer participated in the game. This is because the number of times of participation in the game is a factor that exerts the greatest influence on deviation values as well as on the law of large numbers.

The invention according to the second embodiment further includes the segmentation processing unit 28 configured to segment each customer based on at least the total amount of the resource input by the customer and the total amount of the resource to be given to the customer. The different resource determination unit 24 then determines the type or the amount of the different resource to be provided to the customer based on the segment to which the customer belongs. With this configuration, deciding processing and determination processing are performed based on the segment associated with the record of each customer. Accordingly, the different resource can be allocated appropriately while the amount of calculation can be suppressed.

The invention according to the second embodiment preferably adopts the configuration in which the different resource information storage unit 29 stores suppliers who provide the different resources to the agent, and ratios of supplying prices to market prices when the suppliers supply the different resources to the agent, so that allocation of the different resource can be selected more appropriately in consideration of the profit of the agent. In this case, the segmentation processing unit 28 is configured to place the customer, whose ratio of the resource given from the game to the resource input to the game is lower and whose amount of the input resource is larger, in a higher rank segment, and the different resource allocation unit 25 is configured to allocate the different resource of which ratio of the supplying price to the market price is lower to the customer placed in the lower rank segment by the segmentation processing unit. With this configuration, it becomes possible to achieve flexible increase in the profit while performing appropriate cost control in consideration of a profit and loss point of the agent.

### Third Embodiment

The game management system according to a third embodiment provides the customer with a secondary game via the mobile terminal. Hereinafter, a detailed description is given with reference to the drawings. However, a description of the component members already described in the first and second embodiments will be partially omitted.

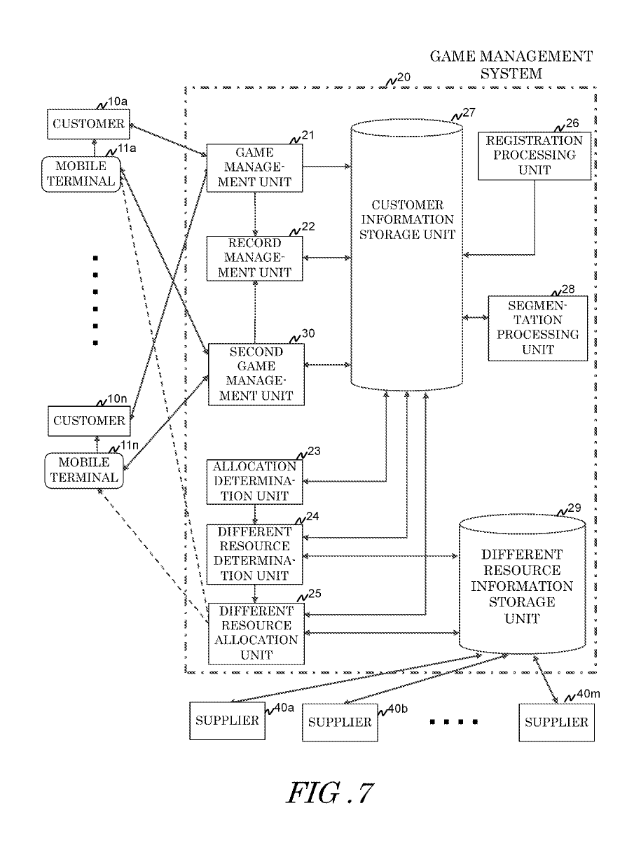

FIG. 7 is a block diagram illustrating the function configuration of a game management system 20 according to the third embodiment. The game management system 20 includes a game management unit 21, a record management unit 22, an allocation determination unit 23, a different resource determination unit 24, a different resource allocation unit 25, a registration processing unit 26, a customer information storage unit 27, a segmentation processing unit 28, and a different resource information storage unit 29. The game management system 20 additionally includes a secondary game management unit 30.

The secondary game management unit 30 communicates with a mobile terminal 11, and provides a customer with a game via the mobile terminal 11. In the following description, the game provided to the customer by the game management unit 21 is called a primary game, and the game provided to the customer by the secondary game management unit 30 via the mobile terminal 11 is called a secondary game.

While the primary game managed by the game management unit 21 is restricted by the resource giving rules (a) and (b) described above, the secondary game managed by the secondary game management unit 30 is a game provided via the mobile terminal 11, which is not restricted by the resource giving rules. That is, while the primary game managed by the game management unit 21 is a game provided in real space based on the resource giving rules, the secondary game managed by the secondary game management unit 30 has a main characteristic of being provided in a virtual space, such as the Internet space, where it is accepted to change, for example, the house edge during the game, or to change the house edge based on the game record of the customer or the segment to which the customer belongs.

The secondary game management unit 30 is configured to be able to provide secondary games which are set to have various kinds of expected values, and to execute a secondary game predetermined by the customer via the mobile terminal 11.

Here, a description is given of the secondary game management unit 30 that can provide the following three secondary games.
Game 1: Expected value of 25% (Parimutuel betting, such as horse races)
Game 2: Expected value of 5.26% (odds betting, such as casinos)
Game 3: Expected value of 1.3% (odds betting, such as casinos)

When the secondary game is played, the customer operates the mobile terminal 11 to input a resource for the secondary game, and receives the resource for secondary games in accordance with the winning and losing result of the game.

The secondary game management unit 30 acquires the play data of the secondary game, and sends it to the record management unit 22.

The record management unit 22 manages both of the primary game record in the game management unit 21 and the secondary game record in the secondary game management unit 30. Both of these game records are stored in the customer information storage unit 27 as record information.

The allocation determination unit 23 determines to allocate to the customer a different resource based on the game record of the customer. In this case, the allocation determination unit 23 may be configured to perform the determination processing based on the overall record including the secondary game record, or may be configured to perform the determination processing based on the primary game record.

The different resource determination unit 24 determines the type or the amount of the different resource to be allocated to the customer based on the game record of the customer. Here, the resource includes a secondary game resource that the customer inputs for the secondary game. For example, the difference resource includes free participation tickets for playing the secondary game, and credits to be input in the secondary game as a resource.

The different resource information storage unit 29 also stores the information of resources for the secondary game as the information of the allocatable different resources.

The different resource allocation unit 25 allocates, to the customer to whom the different resource is determined to be allocated by the allocation determination unit 23, the different resource of the type or the amount determined by the different resource determination unit 24. Specifically, allocation of the different resource is performed by transmitting, to the mobile terminal 11, data of a participation ticket to play the secondary game and credits to be input to the secondary game as a resource.

The mobile terminal 11 which received the different resource for the secondary game from the different resource allocation unit 25 displays the screen of the secondary game on the display panel to inform the customer that the secondary game can be played now. When the customer plays the secondary game, communication is performed between the secondary game management unit 30 and the mobile terminal 11 so as to input and give the resource for the secondary game as well as to transmit and receive game screen data or control data.

Next, specific examples are given to describe the operation of the game management system 20.

Assumed is a case where customers A to D participate in a primary game managed by the game management unit 21. Specifically, the primary game provided by the game management unit 21 is a roulette, and the house edge thereof is set to 5.26%. The customers A to D are each registered members, and their basic information is stored in the customer information storage unit 27. Here, the basic information of each customer is as follows: customer A (male, 25 years old, address), customer B (female, 30 years old, address), customer C (male, 47 years old, address), and customer D (male, 52 years old, address).

For participating in the primary game, each customer has already established a wired or wireless connection between their own mobile terminals 11 and the game management system 20 in order to receive different resources.

The customer A starts with the money of 100,000 yen, bets 100 yen 100 times, and loses 2,000 yen. The expected value in this case is 526 yen.

The customer B starts with the money of 500,000 yen, bets 200 yen 500 times, and wins 6,000 yen. The expected value in this case is 5,260 yen.

The customer C starts with the money of 1 million yen, bets 2,000 yen 1,000 times, and loses 4,500 yen. The expected value in this case is 105,200 yen. The game is assumed to be in progress.

The customer D starts with the money of 2 million yen, bets 1,000 yen 3,000 times, and loses 800,000 yen. The expected value in this case is 157,800 yen. The game is assumed to be in progress.

Here, the segmentation processing unit 28 segments the customers based on the total amount of the resource input by each customer so far. Specifically, each customer is segmented as stated below. That is, the customer having the total amount of bets of less than 100,000 yen is classified into a low customer segment, the customer of 100,000 yen or more and less than 1 million yen is classified into a middle customer segment, and the customer having the total amount of bets of 1 million yen or more is classified into a high customer segment, respectively.

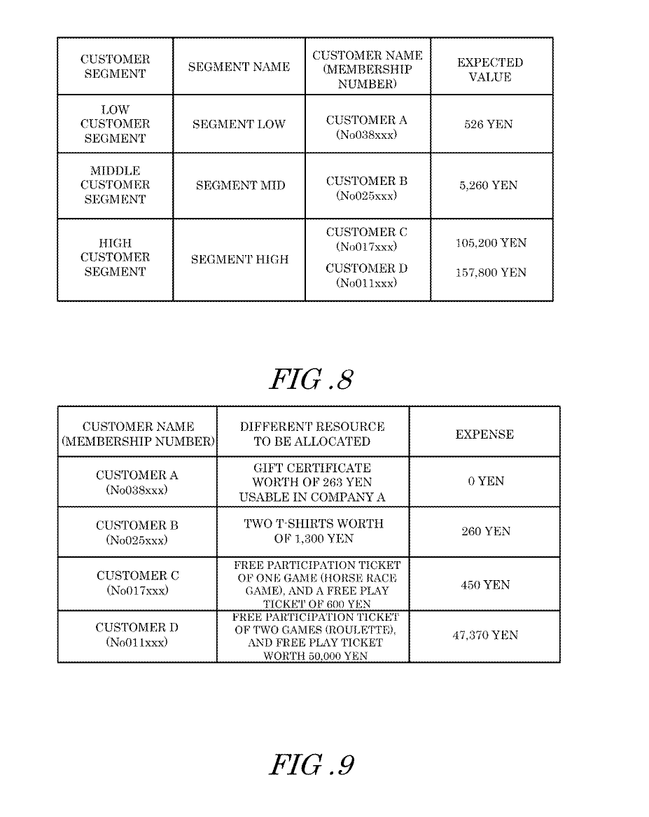

Since the total amount of bets of the customer A is less than 100,000 yen, the customer A belongs to the low customer segment. Since the total amount of bets of the customer B is 100,000 yen or more and less than 1 million yen, the customer B belongs to the middle customer segment. Since the total amounts of bets of the customers C and D are each 1 million yen or more, the customers C and D belong to the high customer segment. The segmentation processing unit 28 performs grouping of each customer in conformity of the condition of each segment, and places the customers in any one of the segments. The status of each customer after segmentation processing is illustrated in FIG. 8.

The different resource determination unit 24 determines the type or the amount of the different resource to be allocated to the customer based on the segment to which the customer belongs. Sales values set as desired by the agent and expenses related thereto are also input in advance in the different resource determination unit 24, and the system is programmed to select the most efficient commodities and service in accordance with the play content of the customer. Here, the different resource determination unit 24 sets an upper limit of the expense usable for each customer within the range of 50% of an expected value, and determines the different resource to be allocated to each customer.

Since the expected value of the customer A is 526 yen as describe above, the maximum expense usable for the customer A is 263 yen. Since the expected value of the customer B is 5,260 yen, the maximum expense usable for the customer B is 2,630 yen. Since the expected value of the customer C is 105,200 yen, the maximum expense usable for the customer C is 52,600 yen. Since the expected value of the customer D is 157,800 yen, the maximum expense usable for the customer D is 78,900 yen.

The different resource determination unit 24 selects a different resource in accordance with a predetermined algorithm within these maximum expenses. FIG. 9 illustrates one example of the different resources selected by the different resource determination unit 24.

Since the customer A belongs to a segment LOW, the different resource determination unit 24 determines to allocate, as a different resource, commodities worth of 263 yen out of a free PR commodity group presented by the company A. Since the cost price of the free gift certificate of the company A is 0 yen, the expense spent by the agent is 0 yen. Data of the free gift certificate is transmitted as information of the different resource to the mobile terminal 11 of the customer A by the different resource transmission unit 251, and is displayed on the display panel of the mobile terminal 11.

Since the customer B belongs to the segment MID, the different resource determination unit 24 determines to allocate two T-shirts of 1,300 yen presented by the company D as a different resource. In this case, the expense spent by the agent is 260 yen. Data of the T-shirt of 2,600 yen is transmitted as information of the different resource to the mobile terminal 11 of the customer B from the different resource transmission unit 251, and is displayed on the display panel of the mobile terminal 11.

Since the customer C belongs to the segment HIGH, the different resource allocation unit 24 determines to allocate, as a different resource, the right for participating in the secondary game provided by the secondary game management unit 30. Here, the different resource allocation unit 24 allocates, as a different resource, a free participation ticket of a horse race that is the above-stated game 1 and a free play ticket (credits) worth of 600 yen. In this case, since the house edge of the horse race game is set to 25%, a real cost is 450 yen. The customer can participate in the horse race of the game 1 with the mobile terminal 11 by using the received free play ticket worth of 600 yen or by inputting his/her own money.

Since the customer D also belongs to the segment HIGH, the different resource determination unit 24 determines to allocate, as a different resource, the right for participating in the secondary game provided by the secondary game management unit 30. Since the house edge for the customer D in the primary game is high, the different resource determination unit 24 determines to allocate more free play tickets. The different resource determination unit 24 determines to allocate a free participation ticket for a roulette game that is the aforementioned game 2, and a free play ticket worth of 50,000 as a different resource. In this case, since the house edge of the roulette game is set to 5.26%, a real expense is 47,370 yen. The customer can participate in the roulette as the game 2 with the mobile terminal 11 by using the received free play ticket worth of 50,000 yen or by inputting his/her own money.

Thus, the different resource allocation unit 25 allocates different resources low in the ratios of the delivery prices to the market prices to the customers who are placed in low ranking segments by the segmentation processing unit 28, so as to provide superior customers with more hospitable supplementary service.

As described above, the invention according to the third embodiment further includes the secondary game management unit 30 configured to provide the secondary game via the mobile terminal 11 owned by the customer. The different resource information storage unit 29 stores, as allocatable different resources, resources that can be input in the secondary game, such as participation tickets and credits for participating in the secondary game provided by the secondary game management unit 30, in addition to free coupons and sales vouchers. In this case, the different resource determination unit 24 determines, as the different resource to be allocated to the customer, a participation ticket to participate in the secondary game provided by the secondary game management unit 30 or a resource that can be input in the secondary game. The different resource allocation unit 25 transmits, to the mobile terminal 11, data of the participation ticket to participate in the secondary game determined by the different resource determination unit 24 or data of the resource that can be input in the secondary game.

According to the invention of the third embodiment having the above-stated characteristics, for increasing the sales of gambles, an influence can be exerted on the profit gained from the primary game and the cost relating thereto by using the secondary game (gambles, games, prizes, etc.) via the mobile terminal 11. In addition, while an influence can be exerted on the profit gained from the primary game and the cost relating thereto by using a secondary return system (free services, presents, discounts, etc.) via the mobile terminal 11, the amount of the returned money can be distributed to the regional communities via the mobile terminal 11.

More specifically, the invention according to the third embodiment can provide a comprehensive system which exerts an influence on the consumption behavior of the customers by providing secondary betting and secondary free service in real time through the mobile terminals 11 owned by the customers and thereby exerting an influence on sales and costs. In the case where the customer is losing with a large deviation from a reference expected value in the primary game, a different resource is allocated so that the customer can play the secondary game for free. As a result, overall game records of the customer such as an overall winning percentage, an overall house edge, and an overall expected value of the games including the primary game and the secondary game, become close to the values such as an winning percentage, a house edge, and an expected value preset as a reference.

More specifically, the record management unit 22 analyzes the pattern of primary betting performed by the customer and thereby correctly analyzes profitability. Based on the resultant data, game service enabling the customer to conduct various secondary betting is provided, so that an influence can be exerted on the expected values and the law of large numbers.

In addition, based on the analytical data obtained by analyzing the pattern of primary betting, a complementary (free service) which is the main service incidental to the gambles is selected, so that a commodity matched with the cost preset by the agent can be selected from a pre-registered commodity group in an optimum cost pattern. The complimentary data, such as gift certificates and coupons, is transferred to the mobile terminal 11 of the customer who is connected to the game machine, and makes the customer use the complimentary in his/her everyday life. As a result, the game is efficiently attached closer to the regional economies, so that the game can effectively play the social roles that the gamble essentially has.

According to the invention in the third embodiment, sales, expenses, and profits in the gambles are not dependent on customer's subjectivity and actions, probabilities, and the law of large numbers. Instead, by providing special betting, free service, cash back (cash return), and the like in real time in accordance with customer data changing at every moment, an influence can be exerted from the psychological and stochastic viewpoint on the betting styles and the number of bets of the customers playing the game. At the same time, by lowering the prices of the gambles or providing free service or coupons, the prices, sales, expenses, and profit prices in the casinos can be managed and controlled to be equal to the set values set by the agent. As a result, stable management can be achieved.

Moreover, by connecting the game management system 20 to the mobile terminals 11, such as smartphones of the customers, the customers can display special betting, free service and coupons on their own terminals, so that the customers can also use these benefits outside the game hall. Therefore, gamble money is consumed in general markets, and can influence activation of the local regions. Since a return of these resources can closely be linked with the consumption behavior of the customers, the source of revenue coming from the gambles flexibly and fluidly spread to the society.

Even when it is legally restricted to change the odds of the authorized and registered game machines in accordance with the play content of individual customers, the invention can be slipped from the frame of the authorization targets by displaying the game on the mobile terminals 11 that belong to the customers. This makes it possible to provide flexible service in accordance with the play of the customers.

It is more preferable to set the house edge of the secondary game lower than the house edge of the primary game. More specifically, the secondary game management unit 30 manages the game with the house edge set lower than the house edge of the game provided by the game management unit 21. Since this configuration increases possibilities of the customers having good result in the secondary game, the customers are motivated to participate in the game, and further input of money can be expected. This can lead to securing the profit on the agent side.

### Fourth Embodiment

A game management system 20 according to a fourth embodiment provides a secondary service or game corresponding to the basic primary game, to efficiently control an average house edge or expected value to be close to a house edge or expected value expected by the agent. Hereinafter, a detailed description is given with reference to the drawings. However, a description of the component members already described in the first to third embodiments will be partially omitted.

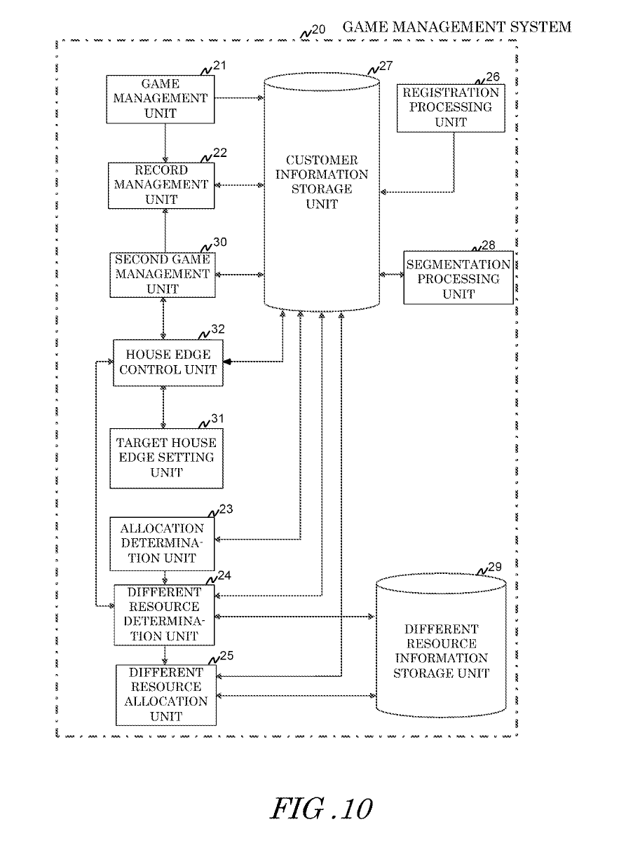

FIG. 10 is a block diagram illustrating the configuration of the game management system 20 according to the fourth embodiment. The game management system 20 further includes a target house edge setting unit 31 and a house edge control unit 32 in addition to the game management unit 21, the record management unit 22, the allocation determination unit 23, the different resource determination unit 24, the different resource allocation unit 25, the registration processing unit 26, the customer information storage unit 27, the segmentation processing unit 28, the different resource information storage unit 29, and the secondary game management unit 30.

The segmentation processing unit 28 segments each customer in accordance with the degree of superiority calculated based on game records of the customers, such as the total amount of bets, the frequency of participation, and an actual winning and losing amount. Here, the segmentation processing unit 28 divides the customers into segments called (1) silver member, (2) gold member, (3) diamond member, and (4) platinum member, based on the degree of superiority of the customers.

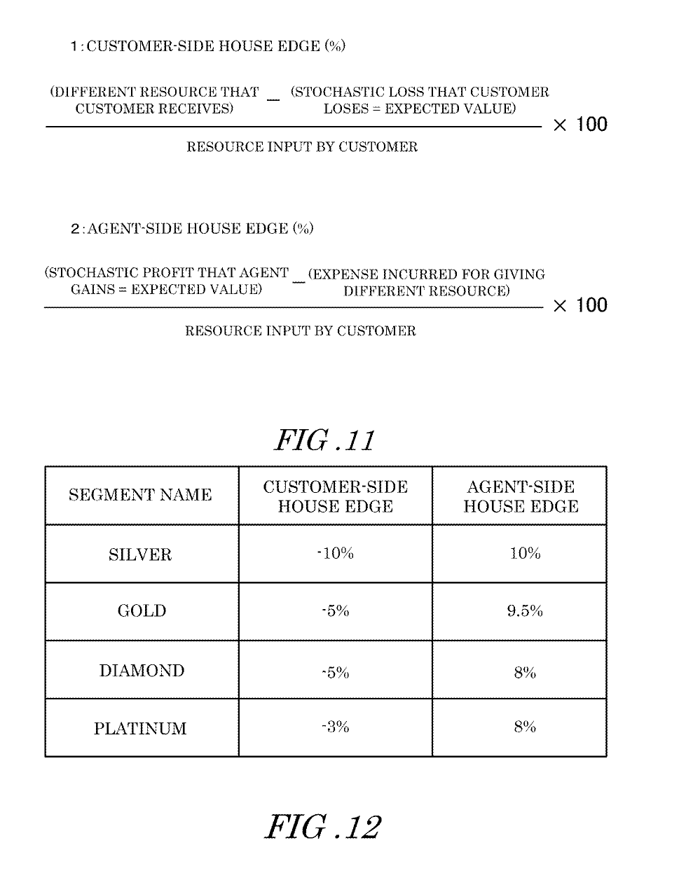

The target house edge setting unit 31 sets, as a target set by the agent, a house edge viewed from the customer side (hereinafter referred to as a customer-side house edge) and an house edge viewed from the agent side (hereinafter referred to as an agent-side house edge) for each segment. The customer-side house edge and the agent-side house edge are expressed by formulae illustrated in FIG. 11. In the formulae of FIG. 11, an expected value which is a stochastic loss that the customer loses and an expected value which is a stochastic profit that the agent gains are the same values.

FIG. 12 illustrates one example of the customer-side house edge and the agent-side house edge for each segment set by the target house edge setting unit 31.

The house edge control unit 32 performs a control such that the actual house edges become closer to the customer-side house edge and the agent-side house edge set by the target house edge setting unit 31. As can be seen from FIG. 11, the customer-side house edge can be changed by changing the different resource or the expected value, and the agent-side house edge can be changed by changing the expense or the expected value of the different resource.

The different resource determination unit 24 determines, under the control of the deduction rate control unit 31, a different resource, and a type or an amount thereof so that the actual house edges each becomes close to the house edges set for the segment to which the customer belongs to.

Under the control of the house edge control unit 31, the secondary game management unit 30 sets the house edges of the secondary game, so that the actual house edges each becomes close to the house edges set for the segment to which the customer belongs, and provides the customer with the secondary game with the set house edges.

Next, specific examples are used to describe the operation of the game management system 20.

Assumed is a case where a customer A who is a silver member participates in the game managed by the game management unit 21 with a house edge of 10%, and inputs money of 100,000 yen. In this case, 10,000 yen obtained by multiplying the input money of 100,000 yen by the house edge of 10% is an expected value that is a stochastic profit of the agent side.

Here, assumed is a case where the game record of the customer A meets a standard of the superior customers, and the customer A is placed in a higher segment. The standard is set based on the total amount of bets, the frequency of participation, the winning and losing amount, and the like. In this case, a target customer-side house edge and a target agent-side house edge for the customer A who became a gold member are changed to 5% and 9.5%, respectively.

When the segment of the customer is changed, the allocation determination unit 23 determines to allocate the customer a different resource. Under the control of the house edge control unit 32, the different resource determination unit 24 determines the type or the amount of the different resource such that the current house edges become close to the customer-side house edge and the agent-side house edge. In this case, the house edge control unit 32 controls the different resource determination unit 24 such that the current house edges become close to the target house edges by allocating the different resource.

To change the customer-side house edge from −10% to −5% and to change the agent house edge from 10% to 9.5%, the different resource determination unit 24 determines to allocate a 5,000-yen free gift certificate with expense of 500 yen as a different resource.

The different resource allocation unit 25 allocates to the customer the free gift certificate determined by the different resource determination unit 24. Specifically, the different resource allocation unit 25 transmits data of the free gift certificate to the mobile terminal 11.

By executing the above processing, the customer-side house edge can be set to a target value of −5% according to the following formula:

100×{5,000 yen (different resource)−10,000 yen (expected value)}/100,000 yen (total input resource)

The agent-side house edge can be set to a target value of 9.5% according to the following formula:

100×{10,000 yen (expected value)−500 yen (expense of different resource)}/100,000 yen (total input resource)

In another method, the different resource determination unit 24 determines a free participation ticket of the game managed by the secondary game management unit 30 as the different resource to be allocated. The different resource allocation unit 25 transmits data of the free participation ticket to the mobile terminal 11.

Here, the secondary game management unit 30 sets the house edge of the secondary game provided to the customer to 0% under the control of the house edge control unit 32.

Assumed is a case where the customer inputs 100,000 yen into the secondary game provided by the secondary game management unit 30. In this case, the expected value as a whole is 10,000 yen according to the following formula:

100,000 yen (bet 1)×10% (house edge)+100,000 yen (bet 2)×0%=10,000 yen (expected value)

A house edge of 5% is achieved by the following formula:

100×10,000 yen (expected value)/200,000 yen (total input resource)

As described above, the invention according to the fourth embodiment further includes the house edge control unit 32 configured to control, based on the game record of the customer, the house edges of the secondary game to be provided to the customer by the secondary game management unit 30. The secondary game management unit 30 provides the customer with the secondary game at the house edge controlled by the house edge control unit 32.

The different resource information storage unit 29 also stores pairs of the market price and the supplying price (cost) of the different resource, and selects a different resource to be allocated, based on the market price of the different resource such that the house edge becomes close to the target house edge set for the customer, while selecting a different resource to be allocated, based on the supplying price of the different resource such that the house edge becomes close to the target house edge set for the agent.

As described in each of the embodiments, in the invention, it becomes possible to provide the customers with different resources different from the resource input and given in the game, and to provide different stochastic games, based on the amounts and the ratios of the resource input by the customers and the resource given to the customers by the agent, a profit and loss point of the agent in the game, and its set value. This makes it possible to motivate the customers to participate in the game without spoiling the profit of the agent and to thereby provide the game management system capable of correcting the game results of the customers which are deviated from set values.

Moreover, the invention has been made by focusing on the fact that in gambles, the actual amount of lost bets and expected values are to be balanced in a long term based on the law of large numbers, though short-term and mid-term results include diversity caused by betting styles and the amount of a bet. Based on this, the sales generated by the play content (such as bets and the number of times of participation) of individual customers that change at every moment, the expenses incurred for returning points, and the deviations between actual game results and expected values are linked to the overall sales in the short and medium term, by which a comprehensive system which controls long-term sales, expenses, and profits is achieved.

Moreover, according to the invention, the expected values obtained in the game and the actual game results can comprehensively be controlled by using free service or secondary games. This makes it possible to promote input of the resource from the customers. More specifically, it becomes possible to provide the game management system which gives not the resource in which the customer participates but the different resources to the terminal of the customer so as to enable the different resources of the amount or the content corresponding to the record of the customer to be given, even in the case of the games having difficulty in changing game machines or the resource providing rule as in the public gambles and the like.

Moreover, according to the invention, different resources different from the resource input and given in the game can be provided for the customers, based on the amounts and the ratios of the resource input to the game by the customers and the resource given to the customers by the agent, and a profit and loss point of the agent in the game. This makes it possible to implement the game management system which can motivate the customers low in the winning percentage to participate in the game without spoiling the profit of the agent.

### Other Embodiments

The invention is not limited to the embodiments disclosed and changes can properly be made. For example, the invention may be constituted of a combination of each of the embodiments. For example, the game management system 20 described above may be constituted of one information processing server (control device), or may be constituted of a plurality of information processing servers or databases connected to each other. The game management system 20 described above may be implemented by executing a program on a computer having a data I/O device, a storage device, an arithmetic unit, and the like. The program may be provided in the form of being recorded on a recording medium. Examples of the recording medium include magnetic disks, magneto-optical disks, CD-ROMs, DVDs, and ROM cartridges.

### INDUSTRIAL APPLICABILITY

The invention is applicable to the system of managing a game wherein a customer input a resource to participate and the resource is returned based on a winning and losing result.

### EXPLANATION OF REFERENCE NUMERALS

10a to 10n Customer

11a to 11n Mobile terminal

20 Game management system

21 Game management unit

22 Record management unit

23 Allocation determination unit

24 Different resource determination unit

25 Different resource allocation unit

26 Registration processing unit

27 Customer information storage unit

28 Segmentation processing unit

29 Different resource information storage unit

30 Secondary game management unit

31 Target house edge setting unit

32 House edge control unit

40a to 40m Supplier

211 Game provision unit

212 Customer identification unit

213 Play data acquisition unit

221 Play data management unit

222 Play data analysis unit

251 Different resource transmission unit

271 Basic information

272 Participation information

273 History information

274 Record information

291 Different resource management file

292a to 292m Different resource

1. A game management system, comprising:
a game management unit configured to manage a game where a customer inputs a resource to participate in and an agent gives a resource to the customer in accordance with a result;
a record management unit configured to manage a game record of each customer based on an input resource and a given resource in the game;
an allocation determination unit configured to determine allocation of a different resource to the customer based on the game record of the customer, the different resource being different from the input resource and the given resource in the game;
a different resource determination unit configured to determine a type or an amount of the different resource to be allocated to the customer, based on the game record of the customer; and
a different resource allocation unit configured to allocate, to the customer to whom the different resource is determined to be allocated by the allocation determination unit, the different resource of the type or the amount determined by the different resource determination unit.

2. The game management system according to claim 1, further comprising
a customer information storage unit configured to store customer information including at least information of a mobile terminal owned by the customer, wherein
the different resource allocation unit transmits data of the different resource of the type or the amount determined by the different resource determination unit, to the mobile terminal owned by the customer to whom the different resource is determined to be allocated by the allocation determination unit.

3. The game management system according to claim 2, wherein
the customer information storage unit stores at least one of an ID, an IP address, an e-mail address, and a telephone number of the mobile terminal, as information of the mobile terminal.

4. The game management system according to claim 1, wherein
the allocation determination unit determines whether or not the game record of the customer managed by the record management unit is lower than a reference record by a predetermined threshold value or more, and determines to allocate the different resource to the customer if the record is lower than the reference record.

5. The game management system according to claim 4, wherein
the allocation determination unit determines whether or not a total amount of the resource input by the customer is over a predetermined threshold value, and determines to allocate the different resource to the customer if the total amount is over the threshold value.

6. The game management system according to claim 4, wherein
the allocation determination unit determines whether or not number of times the customer participated in the game is over a predetermined threshold value, and determines to allocate the different resource to the customer if the number of times is over the threshold value.

7. The game management system according to claim 4, wherein
the allocation determination unit multiplies the total amount of the resource that the customer input in the game by a house edge preset for the game to obtain a reference value, determines whether or not a value, obtained by subtracting a total amount of the resource given to the customer based on the game result from the total amount of the resource input by the customer, is over the reference value by a predetermined threshold value or more, and determines to allocate the different resource to the customer if the value is over the reference value.

8. The game management system according to claim 4, wherein
the game management unit performs the game by applying a same resource giving rule to all the participating customers regardless of the game records of the customers, without changing the resource giving rule for each individual customer by the agent during holding the game, and
the reference record is set based on the resource giving rule.

9. The game management system according to claim 2, further comprising
a secondary game management unit configured to provide a secondary game via the mobile terminal owned by the customer, wherein
the different resource determination unit determines, as the different resource to be allocated to the customer, a participation ticket to participate in the secondary game provided by the secondary game management unit or a resource that can be input in the secondary game, and
the different resource allocation unit transmits, to the mobile terminal, data of the participation ticket to participate in the secondary game or data of the resource that can be input in the secondary game determined by the difference resource determination unit.

10. The game management system according to claim 9, further comprising
a house edge control unit configured to control, based on the game record of the customer, a house edge of the secondary game to be provided to the customer by the secondary game management unit, wherein
the secondary game management unit provides the customer with the secondary game at the house edge controlled by the house edge control unit.

11. The game management system according to claim 1, further comprising
a segmentation processing unit configured to segment each customer based on at least the total amount of the resource input by the customer and the total amount of the resource given to the customer, wherein
the different resource determination unit determines, based on the segment to which the customer belongs, the type or the amount of the different resource to be provided to the customer.

12. The game management system according to claim 11, wherein
the segmentation processing unit segments each customer based on at least a house edge of the customer, a number of times that the customer participated in the game, and an amount of the resource that the customer lost.

13. The game management system according to claim 1, further comprising
a segmentation processing unit configured to segment each customer based on at least one of an amount of money owned by the customer, an amount of the resource input by the customer, an amount of the resource given to the customer, a frequency that the customer participates in the game, a number of times that the customer participated in the game, an age of the customer, a sex of the customer, an occupation of the customer, and an address of the customer, wherein
the different resource determination unit determines, based on the game record of the customer and the segment to which the customer belongs, the type or the amount of the different resource provided to the customer.

14. The game management system according to claim 1, wherein
the different resource determination unit determines the type or the amount of the different resource to be allocated such that an overall profit and loss value of the agent, including the resource input in the game by each customer, the resource given by the agent through the game, and the different resources, will not fall below a break-even point of the agent.

15. The game management system according to claim 1, further comprising
a different resource information storage unit configured to store information of allocatable different resources, wherein
the different resource determination unit selects a different resource to be allocated to the customer from among the allocatable different resources stored in the different resource information storage unit, based on the game record of the customer.

16. The game management system according to claim 1, wherein
the different resource determination unit determines the type or the amount of the different resource to be allocated to the customer such that upon compared to a reference record, the difference between the record of the customer including the different resource to be allocated and the reference record is within a predetermined threshold.

17. The game management system according to claim 11, comprising
a different resource information storage unit configured to store a supplier who provides the different resource for the agent, and a ratio of supplying price to market price when the supplier supplies the different resources to the agent, wherein
the segmentation processing unit places the customer, whose ratio of the resource given by the game to the resource input to the game is lower and whose amount of the input resource is larger, in a higher rank segment, and
the different resource allocation unit allocates the different resource of which ratio of the supplying price to the market price is lower to the customer placed in the lower rank segment by the segmentation processing unit.

18. The game management system according to claim 1, wherein
the different resource is a free ticket which enables the customer to acquire the resource to be input in the game for free.
